(19) United States
(12) Patent Application Publication
(10) Pub. No.: US 2026/0337359 A1
(43) Pub. Date: Oct. 29, 2026

(54) HIGHLY ADAPTABLE SPONGE FOR HOUSEHOLD PRODUCTS AND PREPARATION METHOD THEREOF

(71) Applicant: ZHENGQI NEW MATERIALS TECHNOLOGY(CHANGZHOU) CO., LTD., Changzhou (CN)

(72) Inventors: CUIPING BI, Changzhou (CN); BOWEN GUO, Changzhou (CN); LEI GUO, Changzhou (CN)

(73) Assignee: ZHENGQI NEW MATERIALS TECHNOLOGY(CHANGZHOU) CO., LTD., Changzhou (CN)

(21) Appl. No.: 19/651,880

(22) Filed: Apr. 20, 2026

Related U.S. Application Data
(63) Continuation of application No. PCT/CN2025/116766, filed on Aug. 25, 2025.

(30) Foreign Application Priority Data
Jul. 12, 2024 (CN) 2024109352832

(51) Int. Cl. C08J 9/40; A47L 13/16; C08J 9/00; C08K 9/06; C08L 75/08

(52) U.S. Cl. CPC C08J 9/40; A47L 13/16; C08J 9/0061; C08J 9/0071; C08K 9/06; C08L 75/08; C08J 2375/08; C08J 2405/04; C08J 2483/04; C08K 2201/011; C08L 2203/14; C08L 2205/03; C08L 2207/324

(57) ABSTRACT

The present disclosure relates to the technical field of sponge materials, and in particular, to a highly adaptable sponge for household products and a preparation method thereof. The method includes the steps of: mixing polyether polyol, halloysite nanotubes and natural crystal powder uniformly to obtain a first component; mixing additives to obtain a second component; mixing the first component and the second component uniformly to obtain a mixture, adding toluene diisocyanate to the mixture, and stirring until foaming; heating the foamed organic mixture for curing to obtain a polyurethane sponge; and performing finishing processes on the polyurethane sponge to obtain a highly adaptable sponge for household products. The sponge prepared by the present disclosure is highly adaptable to household products and exhibits durable and excellent flame retardancy.

### CROSS-REFERENCE TO RELATED APPLICATIONS

The application claims priority to Chinese patent application No. 2024109352832, filed on Jul. 12, 2024, the entire contents of which are incorporated herein by reference.

### TECHNICAL FIELD

The present disclosure relates to the technical field of sponge materials, and in particular, to a highly adaptable sponge for household products and a preparation method thereof.

### BACKGROUND

Polyurethane sponge is a foam material produced from polyurethane raw materials, characterized by light weight, softness, shock absorption, insulation, etc. It is widely applied in the home furnishing industry, particularly in furniture manufacturing. Polyurethane sponge is extensively used in furniture manufacturing, mainly for producing furniture products such as sofas, chairs and mattresses. With excellent elasticity and comfort, it can provide favorable support and pressure distribution, making users more comfortable when using such furniture. For instance, in sofas and chairs, polyurethane sponge not only improves the softness of cushions but also effectively absorbs impact and reduces vibration transmitted to the human body. In addition, polyurethane sponge features a long service life and reliable protective performance, which has led to its wide promotion and application in furniture manufacturing. In mattress production, polyurethane sponge provides a better sleeping experience thanks to its outstanding shock absorption. In summary, owing to its properties including light weight, softness, shock absorption and insulation, polyurethane sponge is widely used in the home furnishing industry, especially in furniture manufacturing. Its excellent elasticity and comfort make it an ideal material for furniture manufacturing, bringing users an improved using experience.

Chinese Patent Publication No. CN106279608 discloses an Artemisia argyi polyurethane composite household foam sponge, which is prepared from the following raw materials in parts by weight: microcrystalline cellulose, soybean oil, diethylene glycol, potassium hydroxide, polyether polyol, foaming agent, foam stabilizer, catalyst, toluene diisocyanate, distilled water, tetraethyl orthosilicate, Artemisia argyi and silicone oil. Although the foam sponge pad prepared by the present disclosure exhibits good comfort, environmental friendliness, high resilience and high tensile strength, it lacks flame retardancy as a furniture product and thus presents potential safety hazards.

Chinese Patent Publication No. CN109651643 discloses a flame-retardant polyurethane sponge, a preparation method and use thereof. The method includes the following specific steps: soaking the polyurethane sponge in an aqueous dispersion of halloysite nanotubes, squeezing the polyurethane sponge forcefully, and stirring or sonicating to uniformly coat halloysite nanotubes onto the polyurethane sponge; placing the polyurethane sponge in drying equipment and turning the sponge over at intervals; after gradual evaporation of the liquid, removing the halloysite nanotubes that are not firmly bonded to obtain a halloysite nanotube-coated modified flame-retardant polyurethane sponge. Although the sponge has a certain level of flame retardancy, the flame-retardant components tend to detach from the sponge surface, resulting in the lack of long-term flame retardancy.

### SUMMARY

In order to overcome the above problems in the prior art, the present disclosure provides a highly adaptable sponge for household products and a preparation method thereof. The sponge prepared by the present disclosure is suitable for household products, has high adaptability, and exhibits durable and excellent flame retardancy.

In order to achieve the above object, the present disclosure adopts the following technical solutions.

A method for preparing a highly adaptable sponge for household products, comprising the following steps:
S1, mixing polyether polyol, halloysite nanotubes and natural crystal powder uniformly to obtain a first component;
S2, mixing dibutyltin diacetate and triethylamine uniformly to obtain a composite catalyst, then adding water as a foaming agent, silicone oil as a foam stabilizer, and sodium alginate to the composite catalyst to obtain a second component;
S3, mixing the first component and the second component uniformly to obtain a mixture, adding toluene diisocyanate to the mixture, and stirring until foaming;
S4, heating the foamed organic mixture for curing to obtain a polyurethane sponge;
S5, adding dopamine hydrochloride and glutaraldehyde to Tris buffer solution, stirring and mixing uniformly to obtain a mixed solution, adding modified halloysite nanotubes to the mixed solution, stirring and mixing uniformly, adjusting the pH to 8-9 to obtain a dopamine reaction solution;
S6, soaking the polyurethane sponge obtained in the step S4 in the dopamine reaction solution, heating to react, after the reaction is completed, taking out the polyurethane sponge and drying to obtain a highly adaptable sponge for household products.

The present disclosure incorporates natural crystal powder into a sponge. The infrared rays emitted by the natural crystal powder generate a unique and stable frequency, which enhances the immune system, promotes the rapid elimination of toxins from the body and increases oxygen levels. Since this special frequency shares the same vibration frequency as the human body, it has the functions of relieving muscle tension, slowing heartbeat, relaxing breathing, increasing blood oxygen content, releasing stress and improving sleep quality.

The present disclosure uses polyether polyol and toluene diisocyanate as reaction monomers to prepare polyurethane sponge under the action of a foaming agent and a foam stabilizer. By combining polyurethane sponge with halloysite nanotubes, the present disclosure imparts flame retardancy to the polyurethane sponge by utilizing the flame retardancy of halloysite nanotubes. The flame retardancy of polyurethane sponge is achieved in two ways: on the one hand, halloysite nanotubes are added during the reaction of polyether polyol and toluene diisocyanate, so that halloysite nanotubes are doped inside the polyurethane sponge; on the other hand, a layer of halloysite nanotubes is bonded to the surface of the polyurethane. The synergistic effect of the two approaches endows the polyurethane sponge with good flame retardancy.

In the process of bonding halloysite nanotubes to the polyurethane surface, the halloysite nanotubes tend to detach from the sponge surface when using the ordinary soaking method. Therefore, the present disclosure utilizes the self-polymerization reaction of dopamine to adhere halloysite nanotubes to the surface of polyurethane sponge, thereby improving the bonding force between halloysite nanotubes and the polyurethane sponge surface and solving the problem that halloysite nanotubes tend to detach from the sponge surface.

Preferably, the natural crystal powder in the step S1 is a mixture of the following substances:

fluorite powder, orange calcite powder, sub-graphite powder, bloodstone powder, selenite powder, aragonite powder, tourmaline powder, white crystal powder, amethyst powder, rose quartz powder, aventurine powder, citrine powder, red jasper powder, serpentine powder, and nahcolite powder.

Preferably, the mass ratio of dibutyltin diacetate to triethylamine in the step S2 is 1:(2-3).

Preferably, the dosage of toluene diisocyanate in the step S3 is 40-60 wt % of the polyether polyol in the step S1.

Preferably, the heating and curing temperature in the step S4 is controlled at 60-70 °C.

Preferably, a method for preparing the modified halloysite nanotubes in the step S5 includes the following steps:
adding silane coupling agent KH560 into a mixed solution of ethanol and water with a volume ratio of 10:1, then adding halloysite nanotubes, heating to 50 °C., stirring and reacting at a constant temperature for 2 hours, and performing centrifugal separation, washing and drying to obtain coupling agent-modified halloysite nanotubes;
adding hyperbranched polyethyleneimine into water and stirring to dissolve to prepare a hyperbranched polyethyleneimine solution with a mass concentration of 0.5%, adding the coupling agent-modified halloysite nanotubes into the hyperbranched polyethyleneimine solution, heating to react, and performing centrifugal separation, washing and drying to obtain modified halloysite nanotubes.

Another problem existing in the process of bonding halloysite nanotubes to the polyurethane surface is that halloysite nanotubes are randomly dispersed in the Tris buffer solution, and the amount of halloysite nanotubes dispersed near the polyurethane sponge surface is insufficient to bond with polydopamine to form a halloysite nanotube flame-retardant protective layer. Therefore, the present disclosure conducts surface modification treatment on halloysite nanotubes: first grafting epoxy groups on the surface of halloysite nanotubes, then reacting the epoxy groups with amino groups on hyperbranched polyethyleneimine to graft hyperbranched polyethyleneimine onto halloysite nanotubes, so that a large number of amino groups are loaded on the surface of halloysite nanotubes. Hydrogen bonding force is formed between the amino groups on the surface of halloysite nanotubes and the amino groups on polydopamine on the polyurethane sponge surface, so that more halloysite nanotubes are bonded to the polyurethane sponge surface, thereby forming a halloysite nanotube flame-retardant protective layer.

Preferably, glutaraldehyde is further added to the mixed solution in the step S5.

As described above, in the technical solution of the present disclosure, halloysite nanotubes are adhered to the surface of polyurethane sponge by utilizing the self-polymerization reaction of dopamine, thereby improving the bonding force between halloysite nanotubes and the polyurethane sponge surface and alleviating the problem that halloysite nanotubes tend to detach from the sponge surface. However, the above methods only mitigate the problem of halloysite nanotubes easily detaching from the sponge surface to a certain extent, and cannot completely solve the problem. Therefore, in order to further enhance the bonding force between halloysite nanotubes and the sponge surface, the present disclosure adds glutaraldehyde to the Tris buffer solution. Glutaraldehyde is used to crosslink the amino groups on polydopamine with the amino groups on the surface of halloysite nanotubes, so that halloysite nanotubes are firmly bonded to the polyurethane sponge surface, completely solving the problem of halloysite nanotubes detaching from the sponge surface.

Preferably, sodium alginate is further added to the second component in the step S2.

As described above, in the technical solution of the present disclosure, hydrogen bonding force is formed between the amino groups on the surface of halloysite nanotubes and the amino groups on polydopamine on the polyurethane sponge surface, so that more halloysite nanotubes are bonded to the polyurethane sponge surface, thereby forming a halloysite nanotube flame-retardant protective layer. However, the compactness of the halloysite nanotube flame-retardant protective layer is uneven: a compact halloysite nanotube flame-retardant protective layer is formed in some areas of the sponge surface, while other areas are exposed, which affects the flame retardancy of the polyurethane sponge to a certain extent. To solve this problem, the present disclosure adds sodium alginate during the preparation of polyurethane sponge. Sodium alginate is uniformly dispersed on the polyurethane sponge, so that COO⁻ is loaded on the polyurethane sponge, and the amino groups on the surface of halloysite nanotubes are positively charged. Through electrostatic interaction, halloysite nanotubes are uniformly bonded to the polyurethane sponge surface, so that a uniform and compact halloysite nanotube flame-retardant protective layer is formed on the polyurethane sponge surface, further improving the flame retardancy of the polyurethane sponge.

Preferably, the dosage of sodium alginate is 0.3-0.6 wt % of the mass of the polyether polyol.

A highly adaptable sponge for household products is prepared by the method described above.

The present disclosure has the following beneficial effects:

1) Natural crystal powder is doped into the sponge. The infrared rays emitted by the natural crystal powder generate a unique and stable frequency, which enhances the immune system, promotes rapid elimination of toxins from the body and increases the oxygen level. Since this special frequency shares the same vibration frequency with the human body, it has the functions of relieving muscle tension, slowing heartbeat, relaxing breathing, increasing blood oxygen content, releasing stress and improving sleep quality.

2) On the one hand, halloysite nanotubes are added during the reaction of polyether polyol and toluene diisocyanate, so that halloysite nanotubes are doped inside the polyurethane sponge; on the other hand, a layer of halloysite nanotubes is bonded to the surface of the polyurethane. The synergistic effect of the two approaches endows the polyurethane sponge with good flame retardancy.

3) Surface modification treatment is performed on halloysite nanotubes, so that a large number of amino groups are loaded on the surface of halloysite nanotubes. Hydrogen bonding force is formed between the amino groups on the surface of halloysite nanotubes and the amino groups on polydopamine on the polyurethane sponge surface, so that more halloysite nanotubes are bonded to the polyurethane sponge surface, thereby forming a halloysite nanotube flame-retardant protective layer.

4) Glutaraldehyde is used to crosslink the amino groups on polydopamine with the amino groups on the surface of halloysite nanotubes, so that halloysite nanotubes are firmly bonded to the polyurethane sponge surface, completely solving the problem of halloysite nanotubes detaching from the sponge surface.

5) Sodium alginate is added during the preparation of the polyurethane sponge. Through electrostatic interaction, halloysite nanotubes are uniformly bonded to the polyurethane sponge surface, so that a uniform and compact halloysite nanotube flame-retardant protective layer is formed on the polyurethane sponge surface, further improving the flame retardancy of the polyurethane sponge.

### DETAILED DESCRIPTION OF THE EMBODIMENTS

The present disclosure will be further described in a clear and detailed manner with reference to specific embodiments below. Those skilled in the art will be able to implement the present disclosure based on these descriptions. Furthermore, the embodiments of the present disclosure involved in the following description are usually only a part of the embodiments of the present disclosure, rather than all the embodiments. Therefore, all other embodiments obtained by those skilled in the art based on the embodiments of the present disclosure without creative efforts shall fall within the scope of protection of the present disclosure.

Unless otherwise specified, all raw materials used in the embodiments of the present disclosure are commercially available or obtainable by those skilled in the art; unless otherwise specified, the methods used in the embodiments of the present disclosure are all methods mastered by those skilled in the art.

### Example 1

### Preparation of Modified Halloysite Nanotubes:

Silane coupling agent KH560 was added into a mixed solution of ethanol and water at a mass-to-volume ratio of 1 g/300 mL, in which the volume ratio of ethanol to water was 10:1. Halloysite nanotubes were then added, with the mass ratio of halloysite nanotubes to silane coupling agent KH560 set at 1:0.2. The mixture was heated to 50 °C and stirred for a constant-temperature reaction for 2 hours. Coupling agent-modified halloysite nanotubes were obtained after centrifugal separation, washing and drying.

Hyperbranched polyethyleneimine was added into water and stirred until dissolved, to prepare a hyperbranched polyethyleneimine solution with a mass concentration of 0.5%. The coupling agent-modified halloysite nanotubes prepared above were added into the hyperbranched polyethyleneimine solution. The mixture was heated to 80 °C and kept for reaction for 5 hours. Modified halloysite nanotubes were obtained after centrifugal separation, washing and drying.

A method for preparing a highly adaptable sponge for household products included the following steps:
S1, polyether polyol 330N with a molecular weight of 5,000, halloysite nanotubes and natural crystal powder were mixed uniformly to obtain a first component; wherein the mass ratio of polyether polyol to halloysite nanotubes was 1:0.04, and the mass ratio of polyether polyol to natural crystal powder was 1:0.06;
the natural crystal powder was prepared by mixing the following substances in equal mass:
fluorite powder, orange calcite powder, sub-graphite powder, bloodstone powder, selenite powder, aragonite powder, tourmaline powder, white crystal powder, amethyst powder, rose quartz powder, aventurine powder, citrine powder, red jasper powder, serpentine powder, and nahcolite powder;
S2, dibutyltin diacetate and triethylamine were mixed uniformly at a mass ratio of 1:3 to obtain a composite catalyst; the mass of the composite catalyst was 0.3% of that of polyether polyol. The foaming agent water (10 times the mass of the composite catalyst), the foam stabilizer silicone oil (5 times the mass of the composite catalyst) and sodium alginate were then added into the composite catalyst to obtain a second component; wherein the dosage of sodium alginate was 0.5% of the mass of polyether polyol;
S3, the first component and the second component were mixed uniformly to obtain a mixture; toluene diisocyanate was added into the mixture at a dosage of 55 wt % of polyether polyol; the mixture was stirred until foaming, and stirring was continued for 30 seconds after foaming;
S4, the foamed organic mixture was heated at 70 °C for curing, with the curing time controlled at 5 hours, and a polyurethane sponge was obtained;
S5, dopamine hydrochloride and glutaraldehyde were added into Tris buffer solution; the mass ratio of dopamine hydrochloride to Tris buffer solution was 1:2, and the dosage of glutaraldehyde was 1.0 wt % of dopamine hydrochloride; the mixture was stirred uniformly to obtain a mixed solution; modified halloysite nanotubes were added into the mixed solution at a mass ratio of 1:3 (modified halloysite nanotubes to dopamine hydrochloride); the mixture was stirred uniformly, and the pH value was adjusted to 9; a dopamine reaction solution was obtained;
S6, the polyurethane sponge obtained in the step S4 was soaked in the dopamine reaction solution, heated to 60 °C and kept for reaction for 10 hours; after the reaction was completed, the polyurethane sponge was taken out and dried in an oven at 50 °C for 8 hours to obtain a highly adaptable sponge for household products.

### Example 2

### Preparation of Modified Halloysite Nanotubes:

Silane coupling agent KH560 was added into a mixed solution of ethanol and water at a mass-to-volume ratio of 1 g/300 mL, in which the volume ratio of ethanol to water was 10:1. Halloysite nanotubes were then added, with the mass ratio of halloysite nanotubes to silane coupling agent KH560 set at 1:0.2. The mixture was heated to 50 °C and stirred for a constant-temperature reaction for 2 hours. Coupling agent-modified halloysite nanotubes were obtained after centrifugal separation, washing and drying.

Hyperbranched polyethyleneimine was added into water and stirred until dissolved, to prepare a hyperbranched polyethyleneimine solution with a mass concentration of 0.5%. The coupling agent-modified halloysite nanotubes prepared above were added into the hyperbranched polyethyleneimine solution. The mixture was heated to 80 °C and kept for reaction for 5 hours. Modified halloysite nanotubes were obtained after centrifugal separation, washing and drying.

A method for preparing a highly adaptable sponge for household products included the following steps:
S1, polyether polyol 330N with a molecular weight of 5,000, halloysite nanotubes and natural crystal powder were mixed uniformly to obtain a first component; wherein the mass ratio of polyether polyol to halloysite nanotubes was 1:0.03, and the mass ratio of polyether polyol to natural crystal powder was 1:0.06;
the natural crystal powder was prepared by mixing the following substances in equal mass:
fluorite powder, orange calcite powder, sub-graphite powder, bloodstone powder, selenite powder, aragonite powder, tourmaline powder, white crystal powder, amethyst powder, rose quartz powder, aventurine powder, citrine powder, red jasper powder, serpentine powder, and nahcolite powder;
S2, dibutyltin diacetate and triethylamine were mixed uniformly at a mass ratio of 1:2 to obtain a composite catalyst; the mass of the composite catalyst was 0.3% of that of polyether polyol. The foaming agent water (10 times the mass of the composite catalyst), the foam stabilizer silicone oil (5 times the mass of the composite catalyst) and sodium alginate were then added into the composite catalyst to obtain a second component; wherein the dosage of sodium alginate was 0.4% of the mass of polyether polyol;
S3, the first component and the second component were mixed uniformly to obtain a mixture; toluene diisocyanate was added into the mixture at a dosage of 45 wt % of polyether polyol; the mixture was stirred until foaming, and stirring was continued for 30 seconds after foaming;
S4, the foamed organic mixture was heated at 60 °C for curing, with the curing time controlled at 5 hours, and a polyurethane sponge was obtained;
S5, dopamine hydrochloride and glutaraldehyde were added into Tris buffer solution; the mass ratio of dopamine hydrochloride to Tris buffer solution was 1:2, and the dosage of glutaraldehyde was 1.0 wt % of dopamine hydrochloride; the mixture was stirred uniformly to obtain a mixed solution; modified halloysite nanotubes were added into the mixed solution at a mass ratio of 1:3 (modified halloysite nanotubes to dopamine hydrochloride); the mixture was stirred uniformly, and the pH value was adjusted to 8; a dopamine reaction solution was obtained;
S6, the polyurethane sponge obtained in the step S4 was soaked in the dopamine reaction solution, heated to 60 °C and kept for reaction for 10 hours; after the reaction was completed, the polyurethane sponge was taken out and dried in an oven at 50 °C for 8 hours to obtain a highly adaptable sponge for household products.

### Example 3

### Preparation of Modified Halloysite Nanotubes:

Silane coupling agent KH560 was added into a mixed solution of ethanol and water at a mass-to-volume ratio of 1 g/300 mL, in which the volume ratio of ethanol to water was 10:1. Halloysite nanotubes were then added, with the mass ratio of halloysite nanotubes to silane coupling agent KH560 set at 1:0.2. The mixture was heated to 50 °C and stirred for a constant-temperature reaction for 2 hours. Coupling agent-modified halloysite nanotubes were obtained after centrifugal separation, washing and drying.

Hyperbranched polyethyleneimine was added into water and stirred until dissolved, to prepare a hyperbranched polyethyleneimine solution with a mass concentration of 0.5%. The coupling agent-modified halloysite nanotubes prepared above were added into the hyperbranched polyethyleneimine solution. The mixture was heated to 80 °C and kept for reaction for 5 hours. Modified halloysite nanotubes were obtained after centrifugal separation, washing and drying.

A method for preparing a highly adaptable sponge for household products included the following steps:
S1, polyether polyol 330N with a molecular weight of 5,000, halloysite nanotubes and natural crystal powder were mixed uniformly to obtain a first component; wherein the mass ratio of polyether polyol to halloysite nanotubes was 1:0.03, and the mass ratio of polyether polyol to natural crystal powder was 1:0.06;
the natural crystal powder was prepared by mixing the following substances in equal mass:
fluorite powder, orange calcite powder, sub-graphite powder, bloodstone powder, selenite powder, aragonite powder, tourmaline powder, white crystal powder, amethyst powder, rose quartz powder, aventurine powder, citrine powder, red jasper powder, serpentine powder, and nahcolite powder;
S2, dibutyltin diacetate and triethylamine were mixed uniformly at a mass ratio of 1:2.5 to obtain a composite catalyst; the mass of the composite catalyst was 0.3% of that of polyether polyol. The foaming agent water (10 times the mass of the composite catalyst), the foam stabilizer silicone oil (5 times the mass of the composite catalyst) and sodium alginate were then added into the composite catalyst to obtain a second component; wherein the dosage of sodium alginate was 0.45% of the mass of polyether polyol;
S3, the first component and the second component were mixed uniformly to obtain a mixture; toluene diisocyanate was added into the mixture at a dosage of 50 wt % of polyether polyol; the mixture was stirred until foaming, and stirring was continued for 30 seconds after foaming;
S4, the foamed organic mixture was heated at 65 °C for curing, with the curing time controlled at 5 hours, and a polyurethane sponge was obtained;
S5, dopamine hydrochloride and glutaraldehyde were added into Tris buffer solution; the mass ratio of dopamine hydrochloride to Tris buffer solution was 1:2, and the dosage of glutaraldehyde was 1.0 wt % of dopamine hydrochloride; the mixture was stirred uniformly to obtain a mixed solution; modified halloysite nanotubes were added into the mixed solution at a mass ratio of 1:3 (modified halloysite nanotubes to dopamine hydrochloride); the mixture was stirred uniformly, and the pH value was adjusted to 8.5; a dopamine reaction solution was obtained;
S6, the polyurethane sponge obtained in the step S4 was soaked in the dopamine reaction solution, heated to 60 °C and kept for reaction for 10 hours; after the reaction was completed, the polyurethane sponge was taken out and dried in an oven at 50 °C for 8 hours to obtain a highly adaptable sponge for household products.

### Example 4

### Preparation of Modified Halloysite Nanotubes:

Silane coupling agent KH560 was added into a mixed solution of ethanol and water at a mass-to-volume ratio of 1 g/300 mL, in which the volume ratio of ethanol to water was 10:1. Halloysite nanotubes were then added, with the mass ratio of halloysite nanotubes to silane coupling agent KH560 set at 1:0.2. The mixture was heated to 50 °C and stirred for a constant-temperature reaction for 2 hours. Coupling agent-modified halloysite nanotubes were obtained after centrifugal separation, washing and drying.

Hyperbranched polyethyleneimine was added into water and stirred until dissolved, to prepare a hyperbranched polyethyleneimine solution with a mass concentration of 0.5%. The coupling agent-modified halloysite nanotubes prepared above were added into the hyperbranched polyethyleneimine solution. The mixture was heated to 80 °C and kept for reaction for 5 hours. Modified halloysite nanotubes were obtained after centrifugal separation, washing and drying.

A method for preparing a highly adaptable sponge for household products included the following steps:
S1, polyether polyol 330N with a molecular weight of 5,000, halloysite nanotubes and natural crystal powder were mixed uniformly to obtain a first component; wherein the mass ratio of polyether polyol to halloysite nanotubes was 1:0.05, and the mass ratio of polyether polyol to natural crystal powder was 1:0.06;
the natural crystal powder was prepared by mixing the following substances in equal mass:
fluorite powder, orange calcite powder, sub-graphite powder, bloodstone powder, selenite powder, aragonite powder, tourmaline powder, white crystal powder, amethyst powder, rose quartz powder, aventurine powder, citrine powder, red jasper powder, serpentine powder, and nahcolite powder;
S2, dibutyltin diacetate and triethylamine were mixed uniformly at a mass ratio of 1:3 to obtain a composite catalyst; the mass of the composite catalyst was 0.3% of that of polyether polyol. The foaming agent water (10 times the mass of the composite catalyst), the foam stabilizer silicone oil (5 times the mass of the composite catalyst) and sodium alginate were then added into the composite catalyst to obtain a second component; wherein the dosage of sodium alginate was 0.6% of the mass of polyether polyol;
S3, the first component and the second component were mixed uniformly to obtain a mixture; toluene diisocyanate was added into the mixture at a dosage of 60 wt % of polyether polyol; the mixture was stirred until foaming, and stirring was continued for 30 seconds after foaming;
S4, the foamed organic mixture was heated at 70 °C for curing, with the curing time controlled at 5 hours, and a polyurethane sponge was obtained;
S5, dopamine hydrochloride and glutaraldehyde were added into Tris buffer solution; the mass ratio of dopamine hydrochloride to Tris buffer solution was 1:2, and the dosage of glutaraldehyde was 1.0 wt % of dopamine hydrochloride; the mixture was stirred uniformly to obtain a mixed solution; modified halloysite nanotubes were added into the mixed solution at a mass ratio of 1:3 (modified halloysite nanotubes to dopamine hydrochloride); the mixture was stirred uniformly, and the pH value was adjusted to 9; a dopamine reaction solution was obtained;
S6, the polyurethane sponge obtained in the step S4 was soaked in the dopamine reaction solution, heated to 60 °C and kept for reaction for 10 hours; after the reaction was completed, the polyurethane sponge was taken out and dried in an oven at 50 °C for 8 hours to obtain a highly adaptable sponge for household products.

### Example 5

### Preparation of Modified Halloysite Nanotubes:

Silane coupling agent KH560 was added into a mixed solution of ethanol and water at a mass-to-volume ratio of 1 g/300 mL, in which the volume ratio of ethanol to water was 10:1. Halloysite nanotubes were then added, with the mass ratio of halloysite nanotubes to silane coupling agent KH560 set at 1:0.2. The mixture was heated to 50 °C and stirred for a constant-temperature reaction for 2 hours. Coupling agent-modified halloysite nanotubes were obtained after centrifugal separation, washing and drying.

Hyperbranched polyethyleneimine was added into water and stirred until dissolved, to prepare a hyperbranched polyethyleneimine solution with a mass concentration of 0.5%. The coupling agent-modified halloysite nanotubes prepared above were added into the hyperbranched polyethyleneimine solution. The mixture was heated to 80 °C and kept for reaction for 5 hours. Modified halloysite nanotubes were obtained after centrifugal separation, washing and drying.

A method for preparing a highly adaptable sponge for household products included the following steps:
S1, polyether polyol 330N with a molecular weight of 5,000, halloysite nanotubes and natural crystal powder were mixed uniformly to obtain a first component; wherein the mass ratio of polyether polyol to halloysite nanotubes was 1:0.02, and the mass ratio of polyether polyol to natural crystal powder was 1:0.06;
the natural crystal powder was prepared by mixing the following substances in equal mass:
fluorite powder, orange calcite powder, sub-graphite powder, bloodstone powder, selenite powder, aragonite powder, tourmaline powder, white crystal powder, amethyst powder, rose quartz powder, aventurine powder, citrine powder, red jasper powder, serpentine powder, and nahcolite powder;
S2, dibutyltin diacetate and triethylamine were mixed uniformly at a mass ratio of 1:2 to obtain a composite catalyst; the mass of the composite catalyst was 0.3% of that of polyether polyol. The foaming agent water (10 times the mass of the composite catalyst), the foam stabilizer silicone oil (5 times the mass of the composite catalyst) and sodium alginate were then added into the composite catalyst to obtain a second component; wherein the dosage of sodium alginate was 0.3% of the mass of polyether polyol;
S3, the first component and the second component were mixed uniformly to obtain a mixture; toluene diisocyanate was added into the mixture at a dosage of 40 wt % of polyether polyol; the mixture was stirred until foaming, and stirring was continued for 30 seconds after foaming;
S4, the foamed organic mixture was heated at 60 °C for curing, with the curing time controlled at 5 hours, and a polyurethane sponge was obtained;
S5, dopamine hydrochloride and glutaraldehyde were added into Tris buffer solution; the mass ratio of dopamine hydrochloride to Tris buffer solution was 1:2, and the dosage of glutaraldehyde was 1.0 wt % of dopamine hydrochloride; the mixture was stirred uniformly to obtain a mixed solution; modified halloysite nanotubes were added into the mixed solution at a mass ratio of 1:3 (modified halloysite nanotubes to dopamine hydrochloride); the mixture was stirred uniformly, and the pH value was adjusted to 8; a dopamine reaction solution was obtained;
S6, the polyurethane sponge obtained in the step S4 was soaked in the dopamine reaction solution, heated to 60 °C and kept for reaction for 10 hours; after the reaction was completed, the polyurethane sponge was taken out and dried in an oven at 50 °C for 8 hours to obtain a highly adaptable sponge for household products.

### Comparative Example 1

Comparative Example 1 differed from Example 1 in that:

Dopamine hydrochloride was not added in the step S5.

Other operation steps were the same as those in Example 1.

### Comparative Example 2

Comparative Example 2 differed from Example 1 in that:

The modified halloysite nanotubes were replaced with ordinary halloysite nanotubes.

Other operation steps were the same as those in Example 1.

### Comparative Example 3

Comparative Example 3 differed from Example 1 in that:

Glutaraldehyde was not added in the step S5.

Other operation steps were the same as those in Example 1.

### Comparative Example 4

Comparative Example 4 differed from Example 1 in that:

Sodium alginate was not added in the step S2.

Other operation steps were the same as those in Example 1.

### Comparative Example 5

Comparative Example 5 differed from Example 1 in that:

Natural crystal powder was not added in the step S1.

Other operation steps were the same as those in Example 1.

### Performance Test

1. Flame retardancy test: The flame retardancy of polyurethane sponge was tested according to GB/T 8333-1987 (2008) Test method for flammability of rigid cellular plastics. According to the test results, the higher the oxygen index was, the better the flame retardancy of the sponge was, and vice versa. The test results are shown in Table 1.

TABLE 1

| | | | | | | Com- | Com- | Com- | Com- | Com- |
|---|---|---|---|---|---|---|---|---|---|---|
| | | | | | | para- | para- | para- | para- | para- |
| | | | | | | tive | tive | tive | tive | tive |
| | Exam- | Exam- | Exam- | Exam- | Exam- | Exam- | Exam- | Exam- | Exam- | Exam- |
| | ple 1 | ple 2 | ple 3 | ple 4 | ple 5 | ple 1 | ple 2 | ple 3 | ple 4 | ple 5 |
| Density(kg/ | 47.2 | 45.7 | 46.3 | 46.2 | 45.3 | 47.1 | 47.0 | 47.2 | 47.1 | 47.3 |
| m³) | | | | | | | | | | |
| Oxygen | 28.3 | 27.6 | 27.8 | 28.5 | 27.3 | 23.1 | 21.5 | 28.1 | 25.5 | 28.2 |
| Index(%) | | | | | | | | | | |

2. To test the bonding strength between the flame-retardant halloysite nanotubes on the sponge surface and the sponge, the sponges prepared in Examples 1, 3, 5 and Comparative Examples 1, 3 were placed in an ultrasonic oscillator filled with water and ultrasonically oscillated at a frequency of 20 KHz for 5 hours. The sponges were taken out and dried in an oven at 50 °C. Then the flame retardant performance of the polyurethane sponge was tested according to the GB/T 8333-1987 (2008) Test method for flammability of rigid cellular plastics. The better the flame retardant performance, the higher the bonding strength between the flame-retardant halloysite nanotubes on the sponge surface and the sponge, and the better the durability of the sponge's flame retardant performance. The test results are shown in Table 2.

TABLE 2

| | Example | Example | Example | Comparative | Comparative | Comparative |
|---|---|---|---|---|---|---|
| | 1 | 3 | 5 | Example 1 | Example 2 | Example 3 |
| Oxygen | 28.1 | 27.5 | 27.1 | 21.2 | 19.3 | 25.7 |
| Index (%) | | | | | | |

It could be seen from the comparison between Table 1 and Table 2 (before and after ultrasonic oscillation) that the flame retardancy of the polyurethane sponges prepared in Examples 1-5 was almost unchanged after ultrasonic oscillation, while the flame retardancy of the polyurethane sponges in Comparative Examples 1 and 3 decreased significantly after ultrasonic oscillation. The results demonstrated that the polyurethane sponge prepared in the examples had a firmer bond with the flame-retardant halloysite nanotubes and had more durable flame retardancy compared with Comparative Examples 1 and 3.

3. The tensile strength of polyurethane sponge was tested according to GB/T 6344-2008 Flexible Cellular Polymeric Materials—Determination of Tensile Strength and Elongation at Break. The resilience rate of polyurethane sponge was tested according to GB/T 6670-2008 Flexible Cellular Polymeric Materials—Determination of Resilience by Ball Rebound. The test results are shown in Table 3:

TABLE 3

| | Example 1 | Example 2 | Example 3 | Example 4 | Example 5 |
|---|---|---|---|---|---|
| Tensile | 141 | 139 | 140 | 143 | 138 |
| strength | | | | | |
| (kPa) | | | | | |
| Resilience | 65 | 61 | 62 | 66 | 60 |
| rate (%) | | | | | |

The far-infrared emission performance of the sponge was tested according to GB/T30127-2013. The test results are shown in Table 4.

TABLE 4

| | Example | Example | Example | Example | Example | Comparative |
|---|---|---|---|---|---|---|
| | 1 | 2 | 3 | 4 | 5 | Example 5 |
| Infrared | 0.993 | 0.996 | 0.995 | 0.992 | 0.993 | 0.805 |
| emissivity | | | | | | |

The foregoing description merely describes preferred embodiments of the present disclosure. It should be noted that the above preferred embodiments shall not be considered as limitations on the present disclosure, and the scope of protection of the present disclosure should be determined by the scope defined in the appended claims. For those skilled in the art, several improvements and modifications can be made without departing from the spirit and scope of the present disclosure, and these improvements and modifications should also be considered within the scope of protection of the present disclosure.

What is claimed is:

1. A method for preparing a highly adaptable sponge for household products, comprising the following steps:
S1, mixing polyether polyol, halloysite nanotubes and natural crystal powder uniformly to obtain a first component;
S2, mixing dibutyltin diacetate and triethylamine uniformly to obtain a composite catalyst, then adding water as a foaming agent, silicone oil as a foam stabilizer, and sodium alginate to the composite catalyst to obtain a second component;
S3, mixing the first component and the second component uniformly to obtain a mixture, adding toluene diisocyanate to the mixture, and stirring until foaming;
S4, heating the foamed organic mixture for curing to obtain a polyurethane sponge;
S5, adding dopamine hydrochloride and glutaraldehyde to Tris buffer solution, stirring and mixing uniformly to obtain a mixed solution, adding modified halloysite nanotubes to the mixed solution, stirring and mixing uniformly, adjusting the pH to 8-9 to obtain a dopamine reaction solution;
S6, soaking the polyurethane sponge obtained in the step S4 in the dopamine reaction solution, heating to react, after the reaction is completed, taking out the polyurethane sponge and drying to obtain a highly adaptable sponge for household products;
wherein, a method for preparing the modified halloysite nanotubes in the step S5 comprises the following steps:
adding silane coupling agent KH560 into a mixed solution of ethanol and water with a volume ratio of 10:1, then adding halloysite nanotubes, heating to 50 °C, stirring and reacting at a constant temperature for 2 hours, and performing centrifugal separation, washing and drying to obtain coupling agent-modified halloysite nanotubes;
adding hyperbranched polyethyleneimine into water and stirring to dissolve to prepare a hyperbranched polyethyleneimine solution with a mass concentration of 0.5%, adding the coupling agent-modified halloysite nanotubes into the hyperbranched polyethyleneimine solution, heating to react, and performing centrifugal separation, washing and drying to obtain modified halloysite nanotubes.

2. The method for preparing the highly adaptable sponge for household products according to claim 1, wherein the natural crystal powder in the step S1 is a mixture of the following substances:
fluorite powder, orange calcite powder, sub-graphite powder, bloodstone powder, selenite powder, aragonite powder, tourmaline powder, white crystal powder, amethyst powder, rose quartz powder, aventurine powder, citrine powder, red jasper powder, serpentine powder, and nahcolite powder.

3. The method for preparing the highly adaptable sponge for household products according to claim 1, wherein the mass ratio of dibutyltin diacetate to triethylamine in the step S2 is 1:(2-3).

4. The method for preparing the highly adaptable sponge for household products according to claim 1, wherein the dosage of toluene diisocyanate in the step S3 is 40-60 wt % of the polyether polyol in the step S1.

5. The method for preparing the highly adaptable sponge for household products according to claim 1, wherein the heating and curing temperature in the step S4 is controlled at 60-70 °C.

6. The method for preparing the highly adaptable sponge for household products according to claim 1, wherein the dosage of sodium alginate is 0.3-0.6 wt % of the mass of the polyether polyol.

7. A highly adaptable sponge for household products is prepared by the method of claim 1.
